(19) United States
(12) Patent Application Publication
(10) Pub. No.: US 2008/0273186 A1
(43) Pub. Date: Nov. 6, 2008

(54) Illumination System, In Particular For A Projection Exposure Machine In Semiconductor Lithography

(76) Inventor: Markus Brotsack, Aalen (DE)

Correspondence Address: GRAY ROBINSON, P.A., P.O. Box 2328, FT. LAUDERDALE, FL, 33303-9998, US

(21) Appl. No.: 11/814,685

(22) PCT Filed: Jan. 21, 2006
(86) PCT No.: PCT/EP2006/000535

§ 371 Date: Apr. 3, 2008

(30) Foreign Application Priority Data
Jan. 29, 2005 (DE) 10 2005 004 216.3

(51) Int. Cl. G03B 27/54

(52) U.S. Cl. 355/67

(57) ABSTRACT

An illumination system is provided with a light produced by a light source, with an optical axis and with optical elements, in particular for a projection exposure machine in semiconductor lithography, having at least one optical element for producing a pupil distribution of the light beam, and having a homogenizing element for homogenizing the intensity of the light. For an asymmetric pupil distribution at least the optical elements that produce non-rotationally symmetrical light distributions, and/or the homogenizing element are supported rotatably about the optical axis that forms a z-axis of an x-/y-coordinate system, it being possible to set at least one rotational angle a in such a way that the pupil distribution is located on an axis or symmetrically in relation to an axis of an x′-/y′-coordinate system newly formed by the rotational angle a by means of rotating the x-/y-coordinate system by the angle a.

### CROSS REFERENCE TO RELATED APPLICATION

This application is a U.S. National Phase Entry Under 35 U.S.C. §371 of, and claims priority under 35 U.S.C. §§ 119 and 365 to copending PCT/EP2006/000535, filed Jan. 21, 2006 which designated the U.S. and which claims priority to German Patent Application No. 10 2005 004 216.3, filed Jan. 29, 2005.

### BACKGROUND OF THE INVENTION

1. Field of the Invention

The invention relates to an illumination system, in particular for a projection exposure machine in semiconductor lithography, having a homogenizing element. The invention also relates to a projection exposure machine in semiconductor lithography having an illumination system that has a homogenizing element.

2. Description of the Related Art

The purpose of homogenizing the intensity of a light produced by a light source, for example a laser, is served in an illumination system of a projection exposure machine in semiconductor lithography by a so-called rod integrator by means of which the light is guided and which is preferably arranged with its longitudinal axis parallel to an optical axis of the illumination system. Reflections occur at the walls of the rod, which generally has a flat rectangular shape, the effect being that downstream of the rod pupil distributions, also termed settings, are reflected relative to the x-axis and relative to the y-axis, and therefore symmetrically with reference to this coordinate system. In the case of a rod indictor, for example, in which the edge lengths of the rod that are perpendicular to the longitudinal axis are usually situated along the x- and y-axes, this means that downstream of the rod there is always a symmetrical distribution of a light spot located upstream of the rod, in all four coordinate areas (coordinate quadrants). Symmetrical pupil distributions therefore obtain. In this case, the xyz-coordinate system is defined as a Cartesian coordinate system whose z-axis runs in the longitudinal direction of the rod and through the center of the rod cross section, while the x,y-axes run parallel to the edges of the rectangular illuminated field on the wafer or parallel to the rod edges of the rod cross section when the latter are parallel to the rectangular illuminated field on the wafer. The optical axis runs through the center of the rod cross section.

Reference is made to DE 101 32 988 A1 (U.S. Pat. No. 6,707,537 B2), U.S. Pat. No. 5,675,401 and U.S. Pat. No. 6,285,443 for the prior art.

However, it is also occasionally required that homogenization not be symmetrical relative to the x-/y-coordinate system, or an asymmetric pupil distribution is desired. The standard procedure is for patterns in the wafer to be imaged on the masks vertically or horizontally. Recently, however, there are also patterns that are situated in the x-/y-coordinate system at an angle differing from 90° or 180°. Such structures require an asymmetric pupil distribution. This could certainly be achieved by introducing a stop downstream of the rod in a suitable pupil plane, but it is disadvantageous here that 50% of the light is always lost by vignetting.

### SUMMARY OF THE INVENTION

It is therefore the object of the present invention to achieve an asymmetric pupil distribution without the occurrence of excessively high light losses.

This is achieved according to the invention by virtue of the fact that for an asymmetric pupil distribution at least the optical elements that produce non-rotationally symmetrical light distributions, and/or the homogenizing element are supported rotatably about the optical axis that forms a z-axis of an x-/y-coordinate system, it being possible to set at least one rotational angle a in such a way that the pupil distribution is located on an axis or symmetrically in relation to an axis of an x′-/y′-coordinate system newly formed by the rotational angle a by means of rotating the x-/y-coordinate system by the angle a.

The invention is based on the following findings. When the pupil distributions or settings are located on an axis of the x-/y-coordinate system or run symmetrically relative to a coordinate axis, in the downstream beam path (with reference to the coordinate axis with reference to which the pupil distribution is symmetrical) the settings are then reflected only into themselves by the rod, and no new settings reflected symmetrically in the coordinate system are produced (with reference to the said coordinate axis). However, an asymmetric pupil distribution requires that the setting produced by the optical element correspondingly provided therefor be seated outside the x- or y-axis (or the pupil distribution is asymmetric with reference to at least one axis), as a result of which the rod would give rise to corresponding reflections in all four quadrants of the coordinate system. If, in accordance with the invention, the optical elements that act asymmetrically or produce no rotationally symmetrical distributions (or exhibit astigmatic conditions) are now adjusted by an angle that corresponds to the angle of the desired obliquity of the patterns on the wafer, and the homogenizing element (for example the rod) also rotates about its z-axis such that the pupil distributions are once again symmetrical relative to an x- or y-axis of the homogenizing element (for example of the rod), the distribution (the setting) is, as mentioned, reflected into itself with reference to this axis, and asymmetric pupil distributions can be achieved. The coordinate system of the rotated homogenizing element is denoted by x′, y′, in order to distinguish it from that of the non-rotated one. The adjustment of the asymmetrically acting optical elements and of the homogenizing element (the rod) can be performed synchronously (at the same time) or sequentially. Furthermore, the adjustment angle or rotational angle of the elements or of the homogenizing element can be the same or different, depending on the initial pupil distribution and the desired obliquity that is prescribed by the patterns. It is also possible in this case for an adjustment angle or rotational angle to vanish.

The desired angle of obliquity can be set arbitrarily in this case, and is selected in accordance with the requirements, the outlay for this being relatively slight, since the elements are already present and only their angle need be correspondingly changed.

Although with this solution the scanning field is delimited in x and y and light is also vignetted thereby, the losses are not so high as with the introduction of a stop.

A further substantial advantage of the invention consists in that the same illumination system is suitable for imaging both vertical or horizontal patterns and oblique patterns, owing to the inventive rotatable setting and the associated mounting of the optical elements and the homogenizing element. All the elements are in the “normal position” in the x-/y-coordinate system for “normal operation”. When it is desired to produce oblique patterns on the wafer, it is necessary merely to set the appropriate rotational angle. Since this can be done without great outlay, this results in an illumination system that can be used very universally in accordance with the customer's requirements.

In a particularly advantageous refinement of the invention, it is possible to provide as homogenizing element a rectangular rod integrator that can be rotated by the rotational angle a for an asymmetric pupil distribution.

The solution according to the invention can be used here with particular advantage whenever use is made not of a rod of decidedly rectangular cross section, but of a rod with an at least approximately square profile. In this case, the light loss and the reduction of the field turn out to be substantially smaller than in the case of a decidedly rectangular rod.

Since an asymmetric distribution in the pupil is not desired permanently, it can be provided in an inventive development of the invention that the illumination system is designed such that the rod integrator is exchangeable. In this case, it is possible to work for a “normal method” with a standard scanner rod integrator with a decidedly rectangular profile and, in case of need, to operate with the same illumination system in the case of exchanging the standard rod integrator for a rod integrator of square or approximately square cross section. All that is additionally required in this case is also for the optical elements, which can be, for example, refractive and/or diffractive optical elements in the illumination system, to be provided in a changing device, for example, so that they can be exchanged or else supported rotatably.

In order to be able to achieve maximum freedom of the possible rotational angle and at the same time not to have to accept limitations with reference to the scanner field, it can be provided in an advantageous refinement of the invention that in the case of a square rod the length of the diagonal of an end face of the rod corresponds to the edge length of the rod. Although the light is substantially vignetted in this case, the advantage of the solution with the exchangeable rod integrator by comparison with a rod integrator that is set at an angle consists in that the scanning field can retain the original size, and therefore results in no additional factor that leads to a reduction in throughput.

Advantageous developments and refinements emerge from the remaining subclaims and from the following exemplary embodiment described in principle with the aid of the drawings.

### BRIEF DESCRIPTION OF THE DRAWINGS

FIG. 1 shows a schematic of a projection exposure machine having the illumination system according to the invention;

FIG. 2a shows a diagram of a setting in an x-/y-coordinate system upstream of a homogenizing element;

FIG. 2b shows a diagram of the setting according to FIG. 2a downstream of the homogenizing element;

FIG. 3a shows a diagram of two poles of a dipole setting that are located on the y-axis;

FIG. 3b shows a diagram of two extra-axially arranged poles of a dipole setting;

FIG. 4 shows an illumination system having inventively exchangeable optical elements, and a rotatably arranged rod integrator as homogenizing element;

FIG. 5 shows an enlarged cross section through the rod integrator according to FIG. 4 in two different angular positions with scanning fields;

FIG. 6 shows an illumination system having two exchangeable rod integrators and exchangeable optical elements;

FIG. 7 shows a cross sectional comparison between a rod integrator of square cross section and one of rectangular cross section; and

FIG. 8 shows an illumination system having inventively exchangeable optical elements and a honeycomb condenser as homogenizing element.

### DETAILED DESCRIPTION

The design and the mode of operation of a projection exposure machine having an illumination system that has a rod integrator or a honeycomb condenser, for example, as homogenizing element are known in principle, and for this reason its design and mode of operation are described only briefly below. As an example, reference is made for further details to DE 101 32 988 A1 (U.S. Pat. No. 6,707,537, B2), which thereby forms a part of the disclosure of the subject matter of the application.

A laser, for example, serves as light source 1, and in this case after traversing a beam expander 2 a projection light bundle passes one or more diffractive optical elements 3 arranged in sequence. The diffractive optical element 3 is arranged in the region of an object plane of an objective 4 that is provided, for example, with a zoom lens 5 and an integrated axicon pair 6. The zoom lens 5 can be used to set the focal length of the objective 4 over a relatively large range such that illumination settings or pupil distributions with different maximum illumination angles can be produced. By adjusting the axicon pair 6, moreover, it is possible to set adapted annular illumination settings. A refractive optical element 7 is arranged downstream of the objective 4. Instead of a refractive optical element 7, it is also possible in case of need to provide a further diffractive optical element at this location. Downstream of the refractive optical element 7, a projection light bundle 8 traverses an incoupling optics 9. The incoupling optics 9 transmits the projection light bundle 8 onto an end-face entrance surface 10a of a rod integrator 10 as homogenizing element. The rod integrator 10 mixes and homogenizes the light by means of multiple internal reflection. Located in the region of an exit surface 10b is a field plane of the illumination optics in which a reticle/mask system (ReMa) is arranged. An adjustable field stop 11 is provided for this purpose. Following after the light bundle has traversed the field stop 11 is a further objective 12 having optical elements 13 that are not shown in more detail. Also located in the objective 12 is a pupil plane 14. A deflecting mirror 15 deflects the light bundle, after which, having traversed a further lens group 16, it strikes a reticle 17 on which the field plane of the field stop 11 is imaged. Following the reticle 17 in the usual way is a projection objective 18 downstream of which a wafer 19 is provided for imaging the correspondingly reduced patterns imaged on the reticle.

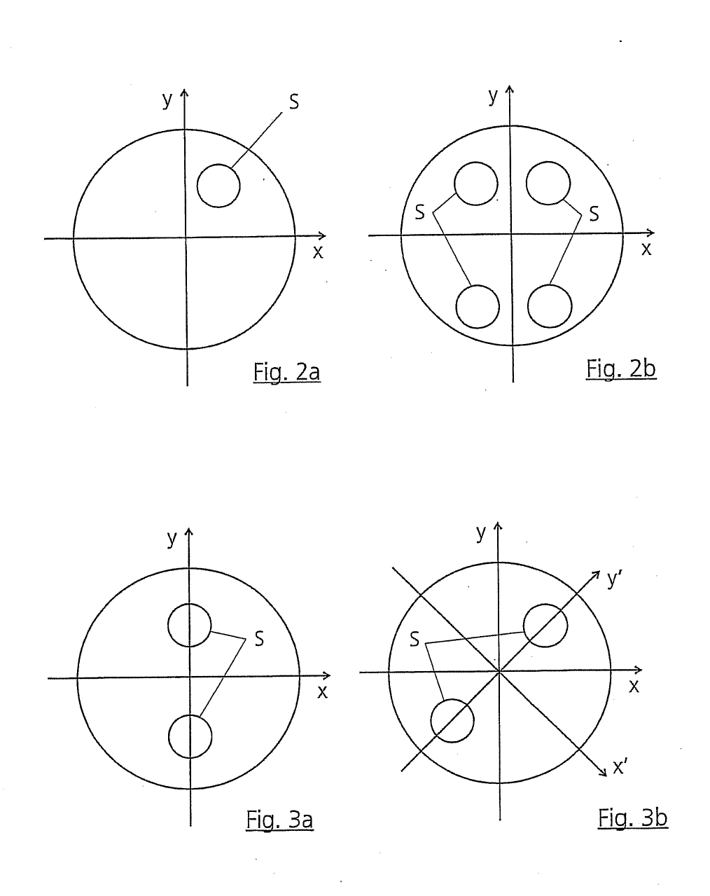

FIG. 2a illustrates the imaging of a pupil distribution S or a setting that is arranged upstream of the homogenizing element, for example the rod integrator 10, off-center and not on one of the two axes of an x-/y-coordinate system. During the homogenization of the light bundle, the setting illustrated in FIG. 2a is reflected relative to the x-axis and relative to the y-axis, and thus symmetrically with reference to the coordinate system, as may be seen from FIG. 2b. This means that if a setting S with a pole “somewhere” in the pupil is guided by the rod integrator 10, a symmetrical distribution is always produced downstream of the rod integrator 10 in all four quadrants of the x-/y-coordinate system if the edge lengths of the rod integrator 10 are situated along the axes x and y.

The procedure is as follows according to the invention, however, if distributions that are not symmetrical relative to the x-/y-coordinate system after the homogenization are required in order to produce patterns on the wafer 19 that are obliquely situated:

The pupil distribution produced by the light source 1 after traversing the beam expander 2, the diffractive optical element 3, the objective 4 and the refractive optical element 7 is selected such that these are imaged on an axis, for example the y-axis of the x-/y-coordinate system, as may be seen from FIG. 3a. According to this refinement, the poles are reflected only into themselves, although in this case a symmetrical arrangement is present in the x-/y-coordinate system. Owing to the optical elements, which are not rotationally symmetrical or exhibit astigmatic conditions and thus differ between the x- and y-directions, and the homogenizing element, for example the rod integrator 10, these would lead correspondingly in a case of an eccentric or asymmetric arrangement of two pupil distributions as illustrated in FIG. 3b to a doubling of the two pupil distributions or poles S, and thus in turn to a symmetrical distribution in accordance with FIG. 2b.

In order to avoid this, the optical elements producing non-rotationally symmetrical conditions, and the rod integrator are now rotated about their optical axis by a rotational angle such that the rotational angle corresponds to the desired obliquity of the patterns on the wafer 19. This means in practice that the x-/y-coordinate system for these optical elements and the rod integrator 10 is rotated about the rotational angle into an x′-/y′-coordinate system, as a result of which the two pupil distributions S again lie on an axis, specifically the new y′-axis, and so there are no additional reflections or duplications: or, in other words, the optical elements and/or the rod integrator are rotated by a rotational angle with reference to the initially defined x-/y-coordinate system such that the pupil distribution is located on an axis of a x′-/y′-coordinate system that emerges from the x-/y-coordinate system by means of rotation by the same rotational angle. This change of coordinate system exerts no influence on the optical elements that are rotationally symmetrical.

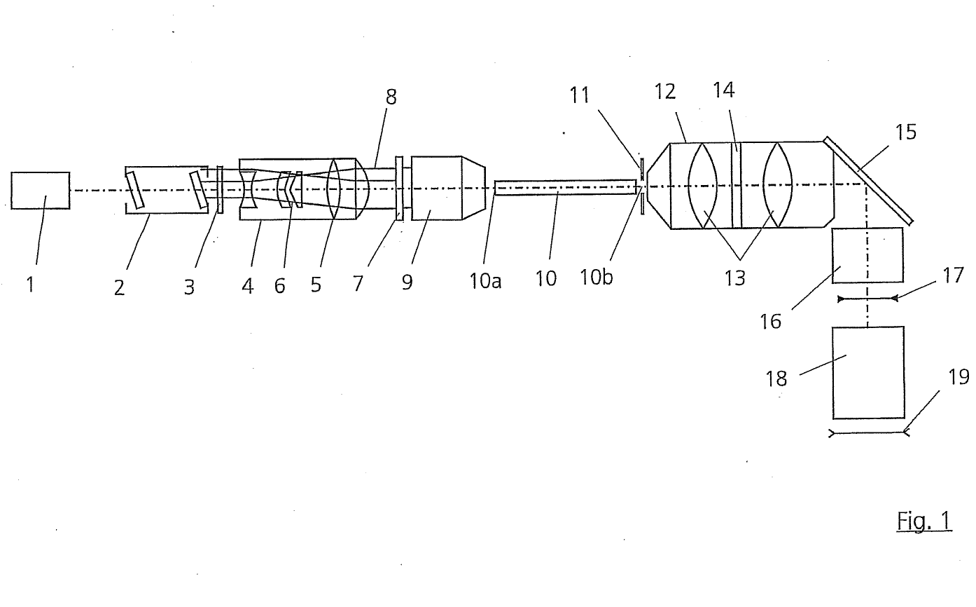

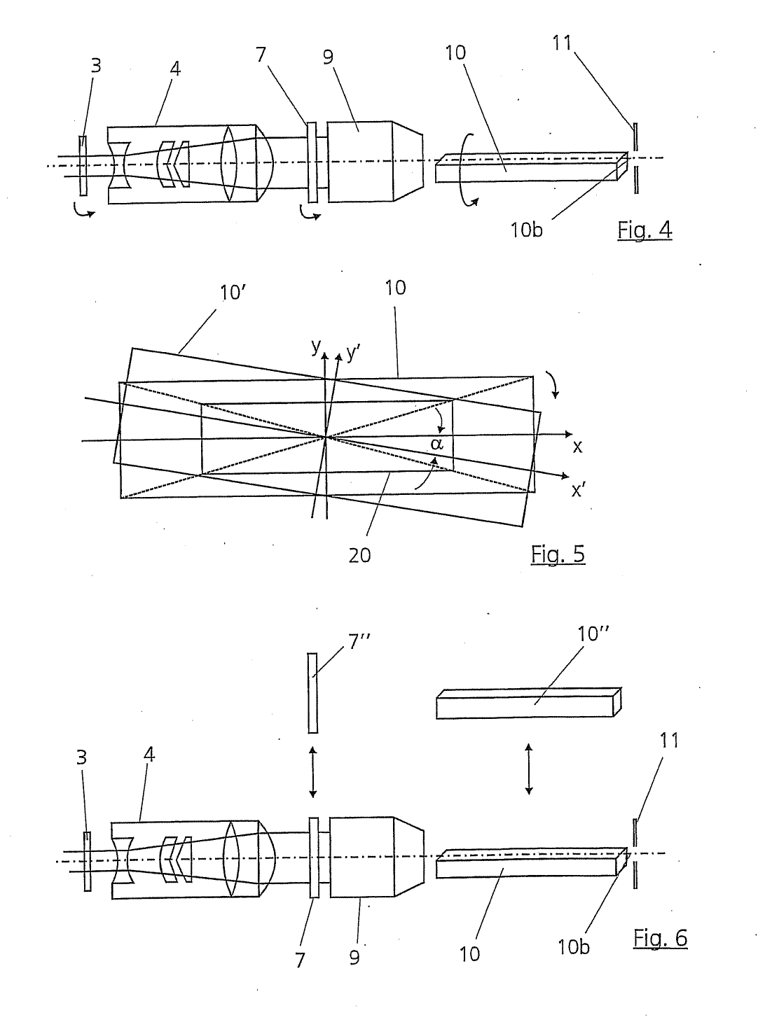

It is to be seen from the arrows in FIG. 4, in which the illumination system according to FIG. 1 is illustrated in an enlarged fashion that for the desired asymmetric distribution according to FIG. 3b the diffractive optical element 3, the refractive optical element 7 and the rod integrator 10 or at least one of these elements are/is arranged in a correspondingly rotatable fashion and are/is adjusted preferably synchronously or sequentially with the aid of the rotational angle that corresponds to the desired obliquity of the patterns. If, for example, a diffractive or refractive optical element is used that produces an asymmetric pole distribution, for example according to FIG. 2a, the rod (the homogenizing element) is thus rotated relative to the x-/y-coordinate system defined at the beginning such that, for example, the rod edges of the rotated rod form an x′-/y′-coordinate system that is situated symmetrically relative to the pole distribution by an angle with respect to the x-/y-coordinate system.

When a “normal” imaging of patterns in a vertical or horizontal direction is desired, the diffractive optical element 3, the refractive optical element 7 and the rod integrator 10 remain in their original position. This means that the same system can be used to image vertical, horizontal and oblique patterns.

As a rule, rod integrators 10 have a decidedly rectangular shape. If such a rod integrator 10 is also used to image oblique patterns of an appropriate rotation, it is unavoidably necessary in the case of prescribed rotational angles to accept a light loss owing to the reduction of the field that turns out to be greater the flatter the rectangular rod integrator 10.

These conditions are apparent from FIG. 5 with the aid of a rod integrator 10 having an edge ratio of 3:1. If such a rod integrator 10 is rotated into the position “10′” by the angle a illustrated relative to the scanning field (x-/y-coordinate system), the result is an adapted scanning field 20 after rotation by the angle a, the sides thereof being limited by the two diagonals of the end face 10a of the rod integrator 10 in the non-rotated position, and by the topside and underside of the rod integrator 10 in the rotated position “10′”. As may be seen, the maximum possible adapted scanning field in the mutually rotated rod sections is situated such that the corner points always lie on the diagonal of the original cross section, in accordance with which the scanning field is reduced along the x-axis and along the y-axis. In addition, the x′-/y′-coordinate system is depicted in the rotated position “10”.

As illustrated in FIG. 6, when the illumination system is being used to produce obliquely situated patterns this patently obvious reduction in the scanning field can be avoided by replacing the decidedly rectangular rod integrator 10 with a rod integrator 10″. In order to adapt to the new, now square cross section of the rod integrator 10″, it can also be necessary in this case likewise to find ways to exchange the other optical elements such as, for example, the refractive optical element 7, for a correspondingly adapted refractive optical element 7′. The size of the scanning field can be maintained in this case. The rectangular rod integrator 10 need not be rotatably supported in this case, since, after all, it is exchanged for the rod integrator 10″ with the square cross section in the case of imaging of obliquely situated patterns.

In order to achieve maximum freedom of a possible rotational angle a and, at the same time, not to have to accept any limitations on the size of the scanning field, the square rod should have the length of the diagonal of the end face of the rod integrator of a rectangular cross section as edge length.

If it is known, for example, that rotational angles a of at most 20° are being used, the rotatable rod integrator 10 or 10″ must then not be square, but can have a somewhat smaller geometry in one direction, the result being that the light loss is not entirely so large.

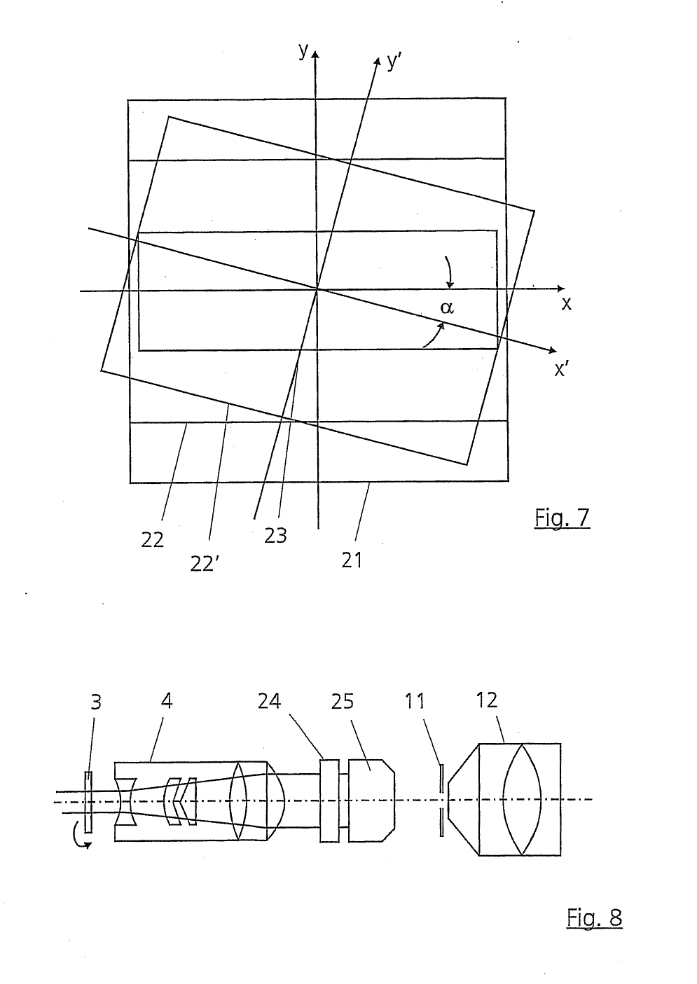

FIG. 7 shows this refinement. The rod integrator of square cross section is provided with the reference numeral 21. An “optimized” rotatable rod of not entirely square cross section is indicated with “22” in a non-rotated position, and with “22′” with a maximum rotation. The reference numeral 23 represents the scanning field resulting from a rotation of the optimized rod integrator.

FIG. 8 shows an exemplary embodiment having a honeycomb condenser 24 as homogenizing element instead of the rod integrator according to the above-described exemplary embodiment. The same design is present in principle, and for this reason the same reference numerals have also been used for the same parts. In this case, the refractive optimum element 7 is not necessary, but is replaced instead by the honeycomb condenser 24. A field lens 25 arranged downstream of the honeycomb condenser 24 in the beam direction acts like the incoupling optics 9 in accordance with FIG. 4. The light mixing is carried out in the honeycomb condenser 24 together with the field lens 25. A desired scanning slot or a field variable is set at the field stop 11 downstream of the honeycomb condenser 24 and the field lens 25. When the honeycomb condenser 24 has correspondingly small honeycombs, the former need not be rotated, if appropriate.

It is also possible to provide an exchangeable element instead of a rotatable diffractive optical element. This means that in the case of an asymmetric pupil distribution the “normal” diffractive optical element is exchanged for a diffractive optical element that produces the asymmetric distribution directly. For this purpose, the diffractive pattern is correspondingly selected such that the “rotated” pattern is produced automatically.

What is claimed is:

1. An illumination system having a light produced by a light source, having an optical axis and having optical elements, in particular for a projection exposure machine in semiconductor lithography, having at least one diffractive optical element for producing a non-rotationally symmetric pupil light distribution of the light beam, and having a homogenizing element for homogenizing the intensity of the light, wherein for an asymmetric pupil distribution at least the diffractive optical elements that produce non-rotationally symmetrical pupil light distribution or the homogenizing element (10) are supported rotatably about the optical axis that forms a z-axis of an x-/y-coordinate system, it being possible to set at least one rotational angle a in such a way that the pupil distribution is located on an axis or symmetrically in relation to an axis of an x′-/y′-coordinate system newly formed by the rotational angle a by means of rotating the x-/y-coordinate system by the angle a.

2. An illumination system having a light produced by a light source, having an optical axis and having optical elements, in particular for a projection exposure machine in semiconductor lithography, having at least one diffractive optical element for producing a non-rotationally symmetric pupil light distribution of the light beam, and having a homogenizing element for homogenizing the intensity of the light, wherein for an asymmetric pupil distribution at least the diffractive optical elements that produce non-rotationally symmetrical pupil light distribution and the homogenizing element (10) are supported rotatably about the optical axis that forms a z-axis of an x-/y-coordinate system, it being possible to set at least one rotational angle a in such a way that the pupil distribution is located on an axis or symmetrically in relation to an axis of an x′-/y′-coordinate system newly formed by the rotational angle a by means of rotating the x-/y-coordinate system by the angle a.

3. The illumination system as claimed in claim 2, wherein at least one rotatable diffractive optical element and the homogenizing element are rotated by the same rotational angle.

4. The illumination system as claimed in claim 2, wherein at least one rotatable diffractive optical element and the homogenizing element are rotated by different rotational angles.

5. The illumination system as claimed in claim 1, wherein provided as homogenizing element is a rectangular rod integrator that can be rotated by the rotational angle a for an asymmetric pupil distribution.

6. The illumination system as claimed in claim 5, wherein the cross section of the rod integrator is at least approximately square.

7. The illumination system as claimed in claim 5, wherein the rod integrator is arranged between an incoupling optics and a field plane having a field stop.

8. The illumination system as claimed in claim 1, wherein at least one diffractive optical element is situated upstream of the homogenizing element in the beam direction.

9. The illumination system as claimed in claim 5, wherein the rod integrator is arranged exchangeably in the illumination system, a rod integrator of square cross section being provided in exchange for a rod integrator of rectangular cross section in conjunction with setting a rotational angle.

10. The illumination system as claimed in claim 9, wherein the length of the diagonal of an end face of the rod integrator of rectangular cross section corresponds at least approximately to the edge length of the rod integrator of square cross section.

11. The illumination system as claimed in claim 1, wherein a honeycomb condenser is provided as homogenizing element.

12. The illumination system as claimed in claim 2, wherein a honeycomb condenser is provided as homogenizing element.

13. A projection exposure machine in semiconductor lithography having an illumination system as claimed in claim 1.

14. A projection exposure machine in semiconductor lithography having an illumination system as claimed in claim 2.

15. An illumination system having a light produced by a light source, having an optical axis and having optical elements, in particular for a projection exposure machine in semiconductor lithography, having at least one optical element for producing a pupil distribution of the light beam, and having a homogenizing element for homogenizing the intensity of the light, wherein for an asymmetric pupil distribution at least the optical elements that produce non-rotationally symmetrical light distributions, or the homogenizing element are supported rotatably about the optical axis that forms a z-axis of an x-/y-coordinate system, it being possible to set at least one rotational angle a in such a way that the pupil distribution is located on an axis or symmetrically in relation to an axis of an x′-/y′-coordinate system newly formed by the rotational angle a by means of rotating the x-/y-coordinate system by the angle a.

16. An illumination system having a light produced by a light source, having an optical axis and having optical elements, in particular for a projection exposure machine in semiconductor lithography, having at least one optical element for producing a pupil distribution of the light beam, and having a homogenizing element for homogenizing the intensity of the light, wherein for an asymmetric pupil distribution at least the optical elements that produce non-rotationally symmetrical light distributions, and the homogenizing element are supported rotatably about the optical axis that forms a z-axis of an x-/y-coordinate system, it being possible to set at least one rotational angle a in such a way that the pupil distribution is located on an axis or symmetrically in relation to an axis of an x′-/y′-coordinate system newly formed by the rotational angle a by means of rotating the x-/y-coordinate system by the angle a.

17. The illumination system as claimed in claim 16, wherein at least one rotatable optical element and the homogenizing element are rotated by the same rotational angle.

18. The illumination system as claimed in claim 16, wherein at least one rotatable optical element and the homogenizing element are rotated by different rotational angles.

19. The illumination system as claimed in claim 15, wherein provided as homogenizing element is a rectangular rod integrator that can be rotated by the rotational angle a for an asymmetric pupil distribution.

20. The illumination system as claimed in claim 19, wherein the cross section of the rod integrator is at least approximately square.

21. The illumination system as claimed in claim 19, wherein the rod integrator is arranged between an incoupling optics and a field plane having a field stop.

22. The illumination system as claimed in claim 15, wherein the optical elements are diffractive and/or refractive optical elements that are situated upstream of the homogenizing element in the beam direction.

23. The illumination system as claimed in claim 19, wherein the rod integrator is arranged exchangeably in the illumination system, a rod integrator of square cross section being provided in exchange for a rod integrator of rectangular cross section in conjunction with setting a rotational angle.

24. The illumination system as claimed in claim 23, wherein the length of the diagonal of an end face of the rod integrator of rectangular cross section corresponds at least approximately to the edge length of the rod integrator of square cross section.

25. The illumination system as claimed in claim 24, wherein refractive optical elements that are arranged upstream of the rod integrator in the beam direction are arranged exchangeably.

26. The illumination system as claimed in claim 15, wherein a honeycomb condenser is provided as homogenizing element.

27. A projection exposure machine in semiconductor lithography having an illumination system as claimed in claim 15.

28. A projection exposure machine in semiconductor lithography having an illumination system as claimed in claim 16.

29. An illumination system having a light produced by a light source, having an optical axis and having optical elements, in particular for a projection exposure machine in semiconductor lithography, having at least one optical element for producing a pupil distribution of the light beam, and having a homogenizing element for homogenizing the intensity of the light, wherein for an asymmetric pupil distribution at least the optical elements that produce non-rotationally symmetrical light distributions, and the homogenizing element are supported rotatably about the optical axis that forms a z-axis of an x-/y-coordinate system, it being possible to set at least one rotational angle a in such a way that the pupil distribution is located on an axis or symmetrically in relation to an axis of an x′-/y′-coordinate system newly formed by the rotational angle a by means of rotating the x-/y-coordinate system by the angle a and wherein at least one rotatable optical element and the homogenizing element are rotated by the same rotational angle.

30. The illumination system as claimed in claim 29, wherein the axis of rotation runs within the at least one optical element.

31. The illumination system as claimed in claim 29, wherein provided as homogenizing element is a rectangular rod integrator that can be rotated by the rotational angle a for an asymmetric pupil distribution.

32. The illumination system as claimed in claim 31, wherein the cross section of the rod integrator is at least approximately square.

33. The illumination system as claimed in claim 29, wherein the optical elements are diffractive and/or refractive optical elements that are situated upstream of the homogenizing element in the beam direction.

34. The illumination system as claimed in claim 29, wherein a honeycomb condenser is provided as homogenizing element.

35. A projection exposure machine in semiconductor lithography having an illumination system as claimed in claim 29.
